(19) United States
(12) Patent Application Publication
(10) Pub. No.: US 2024/0288299 A1
(43) Pub. Date: Aug. 29, 2024

(54) LEVEL MEASURING DEVICE FOR USE IN HIGH-PRESSURE APPLICATIONS

(71) Applicant: VEGA Grieshaber KG, Wolfach (DE)

(72) Inventors: Florian OLSCHEWSKI, Zell am Harmersbach (DE); Juergen DIETMEIER, Hausach (DE)

(73) Assignee: VEGA Grieshaber KG, Wolfach (DE)

(21) Appl. No.: 18/441,333

(22) Filed: Feb. 14, 2024

(30) Foreign Application Priority Data
Feb. 27, 2023 (DE) 10 2023 201 770.9

(51) Int. Cl. G01F 23/284; G01S 7/03

(52) U.S. Cl. CPC G01F 23/284; G01S 7/03

(57) ABSTRACT

A level measuring device configured for use in high-pressure applications with an electronic measuring device and an antenna between which a first waveguide and a second waveguide are arranged, which are connected to one another in a pressure-tight manner with a plastically deformed sealing area being located between the two waveguides.

### CROSS-REFERENCE TO RELATED APPLICATIONS

This application claims the benefit of the filing date of German Patent Application No. 10 2023 201 770.9 filed on 27 Feb. 2023, the entire content of which is incorporated herein by reference.

### TECHNICAL FIELD

The present disclosure relates to level measurement in process automation in industrial and private environments. In particular, the present disclosure relates to a level measuring device which is configured in particular for use in high-pressure applications.

### TECHNICAL BACKGROUND

Level measuring devices are used in process automation in industrial or private environments. Examples of such level measuring devices are radar level measuring devices that emit a radar transmission signal in the direction of the product surface and receive and evaluate the reflected signal. This is used to calculate the fill level.

The level measuring devices can be configured for installation in a container or a container opening. In order to protect the electronics from the container atmosphere, a seal can be provided between the antenna and the meter housing containing the electronics.

Examples of such seals are windows that are permeable to the radar transmission signal.

### SUMMARY

There may be a desire to provide an alternative level measuring device for use in high-pressure applications.

This desire is met by the features of the independent patent claim. Further embodiments of the present disclosure result from the sub-claims and the following description of embodiments.

A first aspect of the present disclosure relates to a level measuring device that can be configured for use in high-pressure applications. It has an electronic measuring device which is configured to generate a (radar) transmission signal. An antenna is also provided, which serves to radiate the transmission signal in the direction of the product surface.

Furthermore, the level measuring device has a first waveguide and a second waveguide, which are connected to each other in a sealed, in particular pressure-tight manner and are configured to transmit the transmission signal from the measuring electronics to the antenna, from where it is then emitted. These two waveguides also serve to return the transmitted signal reflected from the product surface and received by the antenna to the electronic measuring device.

The first waveguide may be inserted or screwed into the second waveguide. By inserting or screwing it in, a sealing area located on the first waveguide and/or the second waveguide (where the two waveguides touch each other) is plastically deformed so that it develops a good sealing effect.

In this way, an efficient sealing effect may be provided without the need to use a sealing ring, a window or a matching cone, which is provided at the antenna end of the second waveguide, for example.

In particular, it may be provided that a pressure-tight connection is created by inserting or screwing in, which is suitable for use in high-pressure applications of 2000 bar or higher.

According to an embodiment of the present disclosure, the connection of the first waveguide to the second waveguide is a positive connection or a non-positive connection.

According to an embodiment of the present disclosure, the plastically deformed sealing area is an integral part of the first waveguide or the second waveguide. It is therefore not an extra element, such as a sealing ring.

According to a further embodiment of the present disclosure, the first waveguide and the second waveguide each have an end face on which they sit on each other or abut against each other. In this case, the plastically deformed sealing area is arranged on the end face of the first waveguide and/or the end face of the second waveguide.

If the two waveguides are now pressed together, for example by screwing them together, the sealing area deforms and ensures a good sealing effect.

According to a further embodiment of the present disclosure, the first waveguide has the same inner diameter as the second waveguide, so that there is no step that the transmission signal has to overcome on its way to the antenna.

According to a further embodiment of the present disclosure, the antenna is integrally connected to the second waveguide.

According to a further embodiment of the present disclosure, the second waveguide has a cylindrical or conical guide surface against which the first waveguide radially abuts in order to guide and center the first waveguide when it is inserted or screwed into the second waveguide.

According to a further embodiment of the present disclosure, the first waveguide has an external thread which is screwed into a corresponding internal thread of the second waveguide.

According to a further embodiment of the present disclosure, the connection of the first waveguide to the second waveguide is designed to withstand a pressure of at least 640 bar, so that the level measuring device can be used for high-pressure applications.

In addition to the seal provided by the plastically deformable sealing area, a matching cone, typically in the form of a ceramic cone, can be provided inside the waveguide, such as a glass window located in front of the measuring device electronics. The waveguide can also be mounted on the glass window in a cone-sealing manner.

This may provide a sufficient sealing effect with a low risk of failure.

Further embodiments are described below. If the same reference signs are used in the following figures, these denote the same or similar elements. The illustrations in the figures are schematic and not to scale.

### BRIEF DESCRIPTION OF THE FIGURES

FIG. 1 shows a level measuring device according to one embodiment of the present disclosure.

FIG. 2 shows a detailed view of a section of the level measuring device of FIG. 1.

### DETAILED DESCRIPTION OF EMBODIMENTS

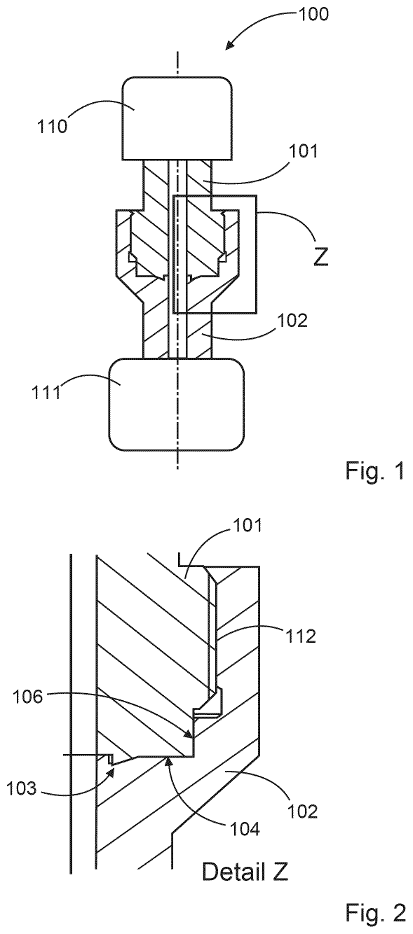

FIG. 1 shows a level measuring device 100 that is configured for use in high-pressure applications. It has an electronic measuring device 110 and an antenna 111. The electronic measuring device 110 is used to generate a transmitted signal and to evaluate the received signal. The antenna 111 is used to radiate the transmitted signal in the direction of the product.

Between the electronic measuring device 110 and the antenna 111 there is a first waveguide 101 and a second waveguide 102, which are pushed into each other and possibly screwed together. There is no other element between the two waveguides; instead, they abut directly against each other.

FIG. 2 shows a detailed illustration of the transition area between the two waveguides 101, 102. The two waveguides 101, 102 are screwed into each other, for example. A corresponding thread is provided in the area 112 for this purpose. At the end face 104 of the first waveguide 101, this abuts against a corresponding face of the second waveguide 102. In this face, the second waveguide has an annular indentation which, for example, has a triangular cross-section. In the same area, the end face 104 of the first waveguide 101 has a projection that is also annular and triangular in cross-section, but which has a different angle of inclination (slightly larger) than the recess in the surface of the second waveguide 102. A crowned contour may also be provided.

If the first waveguide 101 is now screwed into the second waveguide 102 or (if no screw-in thread is provided) pressed against the second waveguide 102, the plastic sealing area 103 is deformed so that it achieves a very effective sealing effect.

In this context (i.e., in context of the triangular projection), one may also speak of a metallic cone seal.

In this way, a temperature-stable high-pressure seal is provided. A cylindrical or conical guide surface 106 can be provided to precisely center the two waveguides 101, 102 against each other.

This sealing arrangement may provide a main seal or a secondary seal to increase safety in the event that a first sealing arrangement should fail.

As a rule, the two waveguides 101, 102 are designed in such a way that the waveguide is not interrupted and there is no offset so that the RF wave (transmission signal) can pass through unhindered.

In particular, a combination of waveguide seal and centering can be provided without additional components.

Additional sealing elements may not be necessary, in particular no O-rings or the like. The two waveguides 101, 102 can be made of stainless steel so that the sealing area 103 is plastically deformed or “eats” during assembly and connects to the sealing surface in the long term or fits snugly against it.

A ceramic cone with a seal can be provided in the waveguide, as well as a glass window. The sealing surface 103 is located between the RF electronics unit (measuring device electronics 110) (for example in the form of a chip or a printed circuit board) and the antenna 111. In particular, a screw connection can be provided between the two waveguides 101, 102.

As an alternative to waveguides made of solid metal, metallized waveguides can be provided, for example made of plastic.

The level measuring device 100 shown can be used on and in containers where high pressures prevail. Advantageously, the sealing arrangement described can prevent a sensor from being destroyed by these high process pressures or from posing a danger to people.

The second waveguide 102 can be sealed towards the antenna with a first safety device, such as a ceramic cone. For better clarity, the ceramic cone is not shown.

For high-temperature applications, it is often necessary for the waveguide to have a certain length in order to prevent the temperature, which migrates from the process towards the measuring device electronics, from migrating into the high-frequency electronics so that they are not damaged. The length of the waveguide therefore protects the measuring device electronics 110 from overheating.

As the cross-section of the waveguide is very small at high frequencies, it is difficult or impossible to produce this waveguide over its entire length. This can be remedied by separating the waveguide and dividing it into several sections (first waveguide 101, second waveguide 102). More than two waveguides can also be provided, whereby the sealing areas described above can be provided in each connection area between the different waveguides.

These sections are shorter again and can be manufactured using production technology, e.g., by drilling. A metallized plastic element can also be used here as an alternative to waveguides made of solid metal.

By sealing the separation point between the two waveguides 101, 102 as described above, a very reliable sealing effect can be achieved. O-rings made of rubber can be used. However, the seal described above in the form of a metallic conical seal offers advantages, for example due to its temperature resistance and service life.

Sealing takes place via a line contact. This line contact is created by different angles on the respective partial surfaces of the plastically deformable seal. In addition to the high temperature resistance, the one-piece design is advantageous.

By providing a cylindrical or conical guide surface 106, a very precise alignment of the two waveguides against each other can be achieved, so that there is no step formation inside the waveguide. The two waveguides 101, 102 are fastened, for example, via a threaded connection 112.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A level measuring device configured for use in an industrial environment, comprising:
radar measuring device electronics configured to generate a transmission signal;
an antenna configured to emit the transmission signal in direction of a product and to receive a reflected transmission signal; and
a first waveguide and a second waveguide, which are connected to each other and are configured to transmit the transmission signal from the measuring electronics to the antenna,
wherein the first waveguide is plugged or screwed into the second waveguide, and
wherein the first waveguide and/or the second waveguide has a sealing region that is plastically deformed by the plugging or screwing of the first waveguide into the second waveguide.

2. The level measuring device according to claim 1,
wherein a pressure-tight connection is created by the plugging or screwing of the first waveguide into the second waveguide.

3. The level measuring device according to claim 1,
wherein the connection of the first waveguide to the second waveguide is a positive connection.

4. The level measuring device according to claim 1,
wherein the plastically deformed sealing region is an integral part of the first waveguide or the second waveguide.

5. The level measuring device according to claim 1,
wherein the first waveguide and the second waveguide each have an end face on which they rest on one another, and
wherein the plastically deformed sealing region is arranged at the end face of the first waveguide or the second waveguide.

6. The level measuring device according to claim 1,
wherein the first waveguide has a same internal diameter as the second waveguide.

7. The level measuring device according to claim 1,
wherein the antenna is integrally connected to the second waveguide.

8. The level measuring device according to claim 1,
wherein the second waveguide has a cylindrical or conical guide surface against which the first waveguide lies radially in order to guide and center the first waveguide during insertion or screwing in.

9. The level measuring device according to claim 1,
wherein the first waveguide has an external thread which is screwed into a corresponding internal thread of the second waveguide.

10. The level measuring device according to claim 1,
wherein the connection of the first waveguide to the second waveguide is designed to withstand a pressure of 640 bar.

11. The level measuring device according to claim 2,
wherein the plastically deformed sealing region is an integral part of the first waveguide or the second waveguide.

12. The level measuring device according to claim 3,
wherein the plastically deformed sealing region is an integral part of the first waveguide or the second waveguide.

13. The level measuring device according to claim 2,
wherein the first waveguide and the second waveguide each have an end face on which they rest on one another, and
wherein the plastically deformed sealing region is arranged at the end face of the first waveguide or the second waveguide.

14. The level measuring device according to claim 3,
wherein the first waveguide and the second waveguide each have an end face on which they rest on one another, and
wherein the plastically deformed sealing region is arranged at the end face of the first waveguide or the second waveguide.

15. The level measuring device according to claim 4,
wherein the first waveguide and the second waveguide each have an end face on which they rest on one another, and
wherein the plastically deformed sealing region is arranged at the end face of the first waveguide or the second waveguide.

16. The level measuring device according to claim 2,
wherein the first waveguide has a same internal diameter as the second waveguide.

17. The level measuring device according to claim 3,
wherein the first waveguide has a same internal diameter as the second waveguide.

18. The level measuring device according to claim 4,
wherein the first waveguide has a same internal diameter as the second waveguide.

19. The level measuring device according to claim 5,
wherein the first waveguide has a same internal diameter as the second waveguide.

20. The level measuring device according to claim 6,
wherein the first waveguide has a same internal diameter as the second waveguide.
